(19) United States
(12) Patent Application Publication
(10) Pub. No.: US 2004/0026232 A1
(43) Pub. Date: Feb. 12, 2004

(54) Method and apparatus for producing nanostructures

(75) Inventors: Raymond Reuven Boxman, Herzliya (IL); Nahum Parkansky, Ra'anana (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(73) Assignee: Ramot at Tel Aviv University Ltd.

(21) Appl. No.: 10/615,141

(22) Filed: Jul. 9, 2003

Related U.S. Application Data
(60) Provisional application No. 60/394,287, filed on Jul. 9, 2002.

(51) Int. Cl. D01F 9/12; B01J 19/08

(52) U.S. Cl. 204/164; 423/447.1; 422/186.04

(57) ABSTRACT

A method for forming nanostructures on a workpiece includes the steps of: positioning a counter-electrode and a workpiece electrode arrangement relative to each other, such that, there is a gap between the counter-electrode and the workpiece electrode arrangement; and applying an electrical pulse between the workpiece electrode arrangement and the counter electrode, such that, an electrical discharge in produced in the gap. The electrical discharge forms at least one nanostructure in a first region of a surface of the workpiece electrode arrangement. The electrical pulse has a duration of less than one millisecond. The first region is selectively determined by a shape of the counter-electrode and a relative positioning of the workpiece electrode arrangement and the counter-electrode. The scope of the invention also includes a system for performing this method.

This application claims the benefit of U.S. Provisional Application No. 60/394,287 filed July 9^{th}, 2002.

### FIELD AND BACKGROUND OF THE INVENTION

The present invention concerns nanostructures, and in particular, it concerns the forming of carbon nanotubes which can serve as field emitters of electrons or probe tips for use in scanning microscopy.

By way of introduction, a field emitter is a device which emits electrons when a strong electric field is applied. In the presence of a strong electric field normal to the emitter surface, electrons can “tunnel” through the potential barrier which normally confines the electrons within solid material. This phenomenon is known as field emission, and is described by the Fowler-Nordheim equation.

Electron emitters are essential components in a variety of devices which utilize electron beams, including various microwave tubes, ionization gauges used to measure vacuum, and cathode ray tubes (CRTs) used for television and computer displays. In most cases, hot filament emitters, which operate on the principle of thermionic emission, are used. Hot filaments, however, require considerable time for warming-up and considerable power for maintaining their temperature, have limited life due to evaporation at their operating temperature, and produce a ‘warm’ electron beam which can adversely affect the performance of some types of microwave tubes.

CRTs are by far the largest user of electron emitters, and the widest used electronic information and image display device. In a CRT, the emitted electrons are accelerated to high energy and swept across a phosphor screen. The impacting electrons excite atoms in the phosphor, which then emit visible light. While CRTs are reasonably priced, and provide a bright display which can be observed over a wide range of viewing angles, they are heavy and large. Rather than using CRTs, portable computers almost universally use flat panel displays based on a matrix of liquid crystal elements which modulate the transmission of back lighting from a fluorescent lamp. Because of the compactness of the flat panel displays, with recent decreases in their price and increases in available sizes, liquid crystal displays (LCDs) are becoming increasingly popular for desktop computer displays as well as television displays. However, the cost of LCDs is still high in comparison to CRTs. Additionally, the brightness, response speed and viewing angle range of LCDs is limited, and higher luminous efficiency is greatly desired.

An alternative display technology is the flat panel field emission display (FFD), in which a two-dimensional array of field emitters is fabricated on one substrate, an array of phosphor light emitting elements are fabricated on another substrate, and the two substrates are mounted opposite each other. Electrons from the field emitters strike and excite the phosphor elements, which emit light, much as in a CRT. It is expected that FEDs can have optical performance better than LCDs and comparable to CRTs, such as high brightness, fast response time, and wide viewing angle.

The critical element in a FED is the field emitter. The field emitter should produce sufficient electron current to obtain the requisite brightness, do so with as small an electrical field as possible, and perform stably during a long service life. In addition, there must be a technique for fabricating the emitters on large substrates economically and reliably. While various materials have been tested for field emission, one of the most promising is a new material known as carbon nanotubes (CNTs). This material was discovered in the last decade, and is a close relative of the C₆₀ molecule which is also known as “Fullerene” or “Bucky-balls”. A CNT is basically a sheet of graphite, which is rolled up to form a tube of a few nanometers in diameter. A CNT may have a single carbon layer or wall, or multiple walls. In some forms, electrical conductivity along the tube is high, having a resistance less than 20 kilo ohms, and because of the high aspect ratio geometry, for example between approximately 100 to 1000, there is considerable field enhancement of between approximately 830 to 3,400 at the tube extremity, allowing electron emission at a relatively low voltage or average field.

CNTs have additional applications, besides field emitters. Because of the small diameter and good mechanical properties of CNTs, and in some cases good electrical conductivity, CNTs can be useful as microscopic probes when mounted as tips in scanning tunneling or atomic force microscopes. For microscopic probes it is desirable to fabricate a single CNT at a specific location on a cantilevered base.

There are several techniques for fabricating CNT field emitters, but they are either slow, expensive, difficult to apply, or require high temperature and hence are not suitable for inexpensive large area substrates, for example glass.

The prior art methods for producing CNTs arc now described.

Carbon nanotubes (CNTs) were first produced, and continue to be produced, in arc discharges, typically approximately 100 Amp discharge current, between graphite electrodes in He gas at between 0.1 and 1 Atm. The CNTs, as well as Fullerenes and other carbon nanoparticles, accumulate in three regions, each with a distinctive particle distribution: as soot on the chamber walls surrounding the electrodes, on the cathode face, and on the cathode stem.

Patterned CNT emitters can be fabricated by collecting arc-produced CNT powder, mixing it with a binder, and then using a printing process to mechanically transfer the mixture to a substrate in a pre-determined pattern. Firing at high temperature vaporizes the binder.

Recently, arc production of CNTs has been examined by Takikawa, et al. Takikawa, et al. substituted a Mo element for the cathode or anode, and found CNT production if and only if the cathode was graphite, suggesting that cathode spot activity is essential. See H. Takikawa, A. Kusano, and Tateki Sakakibara, J. Phys. D: Appl. Phys. 32, 1999, 2433-2437. In another experiment, Takikawa, et al. examined the cathode spot track left on a graphite cathode by a 50 Amp, 1.5 second duration arc, driven in the retrograde direction by a 4 mT magnetic field in a 0.5 Pa He gas background. SEM examination of the arc track revealed the presence of numerous multi-walled CNTs at the last location of the cathode spot, but nowhere else. This suggests that the cathode spot sequentially produced CNTs, and then destroyed them, as the cathode spot moved along the surface at approximately 3 millimeters per second, leaving undestroyed CNTs only at the last cathode spot location. See H. Takikawa, Y. Tao, R. Miyano, T. Sakakibara, X. Zhao, and Y. Ando, Jpn. J. Appl. Phys. 40, 2001, 3414-8.

An alternative route to CNT production is by Chemical Vapor Deposition (CVD) in various forms, and in particular Plasma Assisted Chemical Vapor Deposition (PACVD). In this technique a gaseous or volatile carbon compound, for example, methane or acetylene, disassociates under the influence of a hot surface, such as, a hot substrate or hot filament, or an electrical discharge, and a solid carbon film is deposited on the hot surface. The form of the carbon deposit, for example, diamond, graphite or CNTs, depends upon the deposition conditions. Particularly spectacular results have been achieved when a catalyst, for example Nickel, is first deposited, and the gas includes an etching agent, for example NH₃. Using this technique, Ren et al and Chhowalla et al fabricated arrays of vertically aligned CNTs. See Z. F. Ren, Z. P. Huang, J. W. Xu, J. H. Wang, P. Bush, M. P. Siegal, P. N. Provencia, “Synthesis of Large Arrays of Well-Aligned Carbon Nanotubes on Glass”, Science 282, 1105-7, 1998 and M. Chhowalla, K. B. K. Teo, C. Ducati, N. L. Rupesinghe, G. A. J. Amaratunga, A. C. Ferrari, D. Roy, J. Robertson, and W. I. Milne, “Growth process conditions of vertically aligned carbon nanotubes using plasma enhanced chemical vapor deposition”, J. Appl. Phys. 90, 5308-5317, 2001. However, high substrate temperatures of 660 to 700 degrees Centigrade were required to obtain optimal results.

Pulsed Air Arc Deposition (PAAD) is now described below. PAAD is not used in the prior art for producing CNTs.

Pulsed Air Arc Deposition (PAAD), sometimes referred to as electrospark deposition was developed in the former USSR and in the USA for selectively depositing metallurgical coatings. See G. V. Samsonov. A. D. Verchoturov, G. A. Bovkun, V. S. Sitchev, Spark Discharge Doping, Nauka, Kiev, 1976, p.243; R. N. Johnson, G. L. Sheldon, “Advances in the electro-spark deposition coating process”, J. Vac. Sci. Technol. 4, 1986, 2740-2746; and N. Parkansky, R. L. Boxan, S. Goldsmith, “Development and application of pulsed-air-arc deposition, Surf. Coat. Technol”, 62 (1993) 268-273. A pulsed arc is ignited between the substrate, which acts as the arc cathode, and a small counter-electrode, which acts as the anode, and material is transferred from the anode to the cathode. Intensive heating of the small anode results in melting and evaporation, and the material transferred is believed to consist of both molten particles and vapor. In addition, it is believed that a cathode spot forms, locally heating the substrate surface, causing local melting and evaporation and thus cleaning the substrate surface and allowing for the formation of a strong metallurgical bond between the coating and substrate. The cathode-anode gap is typically 10's of microns, and the pressure of the evaporated material is thought to exceed the air pressure, and thus to expel the ambient air from the short gap, so that oxidation of the coating is relatively low. Commercial units are available in which the counter electrode is mounted on a hand-held vibrator and the arcs are ignited by mechanically contacting and breaking contact with the substrate. Selective coatings arc applied by manually scanning the counter electrode of the desired source material over the area of the substrate on which a coating is required. Thus, for example, zinc coatings can be re-applied to galvanized steel workpieces where the coating was damaged by welding, machining, or corrosion. See Parkansky, R. L. Boxman, S. Goldsmith, Y. Rosenberg, “Corrosion Resistance of Zn—coatings Produced by Pulsed Air Arc Deposition”, Surface and Coating Technology, Vol. 76/77, 1995, pp. 352-357. In all of these coatings and treatments, generally a continuous sequence of pulses is applied, in order to treat an area, with the point of contact of the counter electrode scanned with respect to the workpiece. Each single pulse within the sequence affects some area of the workpiece surface, and generally the scanning rate and pulse repetition rate are arranged, such that, there is some overlap between adjacent affected areas, in order to insure that the desired region of the workpiece surface is completely covered by affected regions. There have been no cases reported in which CNTs were formed by PAAD treatment.

In summary, CNTs have been fabricated by several techniques, including CVD, arcs in near atmospheric pressure He, and arcs in low pressure He. CVD can give spectacular results, for example, a uniform field of orientated CNTs, but CVD requires high substrate temperatures. Conventional high pressure arc techniques can produce large quantities of CNTs, but deposition onto substrates requires processing the CNT containing powder obtained from the arc to make a CNT containing “ink” and printing this material onto the substrate. None of the conventional techniques provides for “selective” deposition at desired locations, except by some form of masking. The various conventional processes are difficult to apply for wide-scale economical production, either because of the high temperatures required with CVD, or the multi-step processing required for “printing” high pressure arc produced CNTs.

PAAD has been used for applying metallurgical coatings on workpieces, generally in a process where treated areas overlap. There has been no prior report of CNT formation using this technique.

Therefore, there is a need for a system and method for fabricating CNTs and other carbon based field emitters on inexpensive substrates at low temperatures. Additionally, there is a need for a method for fabricating nanostructures selectively at designated locations. Additionally, there is a need for an economical method for producing CNT field emitters for flat panel displays and other technological applications, particularly at low temperatures on inexpensive substrates. In particular, there is a need for a method for producing CNT field emitters and probe tips at selected locations, without expensive masking.

### SUMMARY OF THE INVENTION

The present invention is a system for forming nanostructures on a workpiece and method of operation thereof.

According to the teachings of the present invention there is provided, a method for forming nanostructures on a workpiece, comprising the steps of: (a) positioning a counter-electrode and a workpiece electrode arrangement relative to each other, such that, there is a gap between the counter-electrode and the workpiece electrode arrangement; and (b) applying an electrical pulse between the workpiece electrode arrangement and the counter electrode, such that, an electrical discharge in produced in the gap, the electrical discharge forming at least one nanostructure in a first region of a surface of the workpiece electrode arrangement, the electrical pulse having a duration of less than one millisecond.

According to a further feature of the present invention, a maximum dimension of the first region is less than one millimeter.

According to a further feature of the present invention, the electrical pulse has a current pulse amplitude between 1 and 100 Amps.

According to a further feature of the present invention, the electrical discharge is produced in a substantially uncontrolled ambient air atmosphere.

According to a further feature of the present invention, there is also provided the steps, of providing relative movement between the counter-electrode and the workpiece electrode arrangement; and applying another electrical pulse between the workpiece electrode arrangement and the counter electrode in order for an electrical discharge to form at least one nanostructure in a second region of the surface of the workpiece arrangement, the other electrical pulse having a duration of less than one millisecond.

According to a further feature of the present invention, there is also provided the step of selecting a shape of the counter-electrode and a relative positioning of the workpiece electrode arrangement and the counter-electrode in order to selectively determine the first region.

According to a further feature of the present invention, there is also provided the steps of: disposing the workpiece electrode arrangement on to a conveyor system; and actuating the conveyor system so as to provide relative movement between the workpiece electrode arrangement and the counter-electrode.

According to a further feature of the present invention, the counter-electrode includes a carbon rod.

According to a further feature of the present invention, the counter-electrode includes carbon and the workpiece electrode arrangement includes a catalytic metal.

According to the teachings of the present invention there is also provided, a method for forming nanostructures on a workpiece, comprising the steps of: (a) positioning a counter-electrode and a workpiece electrode arrangement relative to each other, such that, there is a gap between the counter-electrode and the workpiece electrode arrangement; and (b) producing an electrical discharge in the gap, the electrical discharge forming at least one nanostructure in a first region of a surface of the workpiece electrode arrangement, wherein the first region is selectively determined by a shape of the counter-electrode and a relative positioning of the workpiece electrode arrangement and the counter-electrode.

According to a further feature of the present invention, the step of producing the electrical discharge in the gap is performed by applying an electrical pulse between the workpiece electrode arrangement and the counter electrode.

According to a further feature of the present invention, a maximum dimension of the first region is less than one millimeter.

According to a further feature of the present invention, the electrical discharge is produced in an atmosphere of at least 50% Helium.

According to a further feature of the present invention, the electrical discharge is produced in a substantially uncontrolled ambient air atmosphere.

According to a further feature of the present invention, there is also provided the steps of: providing relative movement between the counter-electrode and the workpiece electrode arrangement; and producing another electrical discharge in the gap, in order to form at least one other nanostructure in a second region of the surface of the workpiece arrangement.

According to a further feature of the present invention, the counter-electrode includes an elongated element having a tip.

According to a further feature of the present invention, the counter-electrode includes a rod.

According to a further feature of the present invention, the counter-electrode includes a fiber.

According to a further feature of the present invention, there is also provided the steps of moving the counter-electrode until the counter-electrode makes a physical contact with the workpiece electrode arrangement; electrically sensing when the counter-electrode makes the physical contact with the workpiece electrode arrangement; and withdrawing the counter-electrode from the workpiece electrode arrangement by a predetermined distance.

According to a further feature of the present invention, the counter-electrode includes a line.

According to a further feature of the present invention, there is also provided the step of releasing an end of the line towards the workpiece electrode arrangement.

According to a further feature of the present invention, the line includes a plurality of carbon fibers.

According to a further feature of the present invention, there is also provided the steps of: disposing the workpiece electrode arrangement on to a conveyor system; and actuating the conveyor system so as to provide relative movement between the workpiece electrode arrangement and the counter-electrode.

According to a further feature of the present invention, the nanostructure is substantially formed from carbon and wherein at least one of the workpiece electrode arrangement and the counter-electrode include carbon.

According to a further feature of the present invention, at least one of the workpiece electrode and the counter-electrode has a surface region including at least fifty-percent carbon.

According to a further feature of the present invention, the counter-electrode includes at least fifty-percent carbon.

According to a further feature of the present invention, the counter-electrode includes a carbon rod.

According to a further feature of the present invention, the counter-electrode includes a carbon fiber.

According to a further feature of the present invention, the counter-electrode includes carbon and the workpiece electrode arrangement includes a catalytic metal.

According to a further feature of the present invention, the step of producing is performed, such that, the electrical discharge forms at least one carbon nanotube in the first region.

According to a further feature of the present invention, the counter-electrode is a cathode.

According to a further feature of the present invention, the counter-electrode is an anode.

According to the teachings of the present invention there is also provided, a system for producing nanostructures, comprising: (a) a workpiece electrode arrangement having a surface; (b) a counter-electrode, at least one of the workpiece electrode arrangement and the counter-electrode including carbon, the workpiece electrode arrangement and the counter-electrode being positioned, such that, there is a gap between the workpiece electrode arrangement and the counter-electrode; and (c) an electrical voltage supply, the electrical voltage supply being configured to produce an electrical discharge in the gap so as to form at least one carbon-nanotube in a first region of the surface, wherein the counter-electrode is formed in order to selectively determine the first region.

According to a further feature of the present invention, the first region has a maximum dimension, the maximum dimension being less than one millimeter.

According to a further feature of the present invention, a part of the gap in which the electrical discharge is produced has an atmosphere of at least 50% Helium.

According to a further feature of the present invention, a part of the gap in which the electrical discharge is produced has a substantially uncontrolled ambient air atmosphere.

According to a further feature of the present invention, there is also provided a drive mechanism arrangement configured to provide relative movement between the workpiece electrode arrangement and the counter-electrode, such that, the electrical voltage supply is configured to produce another electrical discharge in order to form at least one other carbon nanotube in a second region on the surface of the workpiece electrode arrangement.

According to a further feature of the present invention, the drive mechanism arrangement includes a conveyor apparatus configured for disposing the workpiece electrode arrangement thereon.

According to a further feature of the present invention, at least one of the workpiece electrode and the counter-electrode has a surface region including at least fifty-percent carbon.

According to a further feature of the present invention, the counter-electrode includes at least fifty-percent carbon.

According to a further feature of the present invention, the electrical voltage supply is configured to produce at least one electrical pulse in order to produce the electrical discharge, the electrical pulse having a duration of less than one millisecond.

According to a further feature of the present invention, the electrical pulse has a current pulse amplitude between 1 and 100 Amps.

According to a further feature of the present invention, the counter-electrode includes an elongated element having a tip.

According to a further feature of the present invention, the counter-electrode includes a rod.

The system of claim, wherein the counter-electrode includes a fiber.

According to a further feature of the present invention, there is also provided: a drive mechanism arrangement configured to move the counter-electrode until the counter-electrode makes a physical contact with the workpiece electrode arrangement; and an electrical sensing apparatus configured to sense when the counter-electrode makes the physical contact with the workpiece electrode arrangement, wherein the drive mechanism arrangement is configured to withdraw the counter-electrode from the workpiece electrode arrangement by a pre-determined distance.

According to a further feature of the present invention, the counter-electrode includes a line.

According to a further feature of the present invention, there is also provided a release mechanism arrangement configured to release an end of the line towards the workpiece electrode arrangement.

According to a further feature of the present invention, the line includes a plurality of carbon fibers.

According to a further feature of the present invention, at least one of the workpiece electrode arrangement and the counter-electrode includes graphite.

According to a further feature of the present invention, the electrical voltage supply is configured to operate the counter-electrode as a cathode.

According to the teachings of the present invention there is also provided, a system for producing nanostructures, comprising: (a) a workpiece electrode arrangement having a surface; (b) a counter-electrode, the workpiece electrode arrangement and the counter-electrode being positioned, such that, there is a gap between the workpiece electrode arrangement and the counter-electrode; and (c) an electrical voltage supply, the electrical voltage supply being configured to produce an electrical discharge in the gap so as to form at least one nanostructure in a first region of the surface, wherein the electrical voltage supply is configured to operate the counter-electrode as a cathode.

According to a further feature of the present invention, the first region has a maximum dimension, the maximum dimension being less than one millimeter.

According to a further feature of the present invention, a part of the gap in which the electrical discharge is produced has a substantially uncontrolled ambient air atmosphere.

According to a further feature of the present invention, the electrical voltage supply is configured to produce at least one electrical pulse in order to produce the electrical discharge, the electrical pulse having a duration of less than one millisecond.

According to a further feature of the present invention, the electrical pulse has a current pulse amplitude between 1 and 100 Amps.

### BRIEF DESCRIPTION OF THE DRAWINGS

The invention is herein described, by way of example only, with reference to the accompanying drawings, wherein:

FIG. 1 is schematic isometric view of a system for forming nanostructures on a workpiece that is constructed and operable in accordance with a preferred embodiment of the present invention;

FIG. 2 is a schematic isometric view of a system for forming nanostructures on a workpiece that is constructed and operable in accordance with a first alternate embodiment of the present invention;

FIG. 3 is a schematic isometric view of a system for forming nanostructures on a plurality of workpieces that is constructed and operable in accordance with a second alternate embodiment of the present invention;

FIG. 4 is a scanning electron micrograph of a carbon nanostructure fabricated using the system of FIG. 1;

FIG. 5 is a transmission electron micrograph of a carbon nanostructure fabricated using the system of FIG. 1; and

FIG. 6 is a high-resolution electron micrograph of a multi-walled carbon nanostructure fabricated using the system of FIG. 1.

### DESCRIPTION OF THE PREFERRED EMBODIMENTS

The present invention is a system for forming nanostructures on a workpiece and method of operation thereof.

The principles and operation of a system and method for forming nanostructures on a workpiece according to the present invention may be better understood with reference to the drawings and the accompanying description.

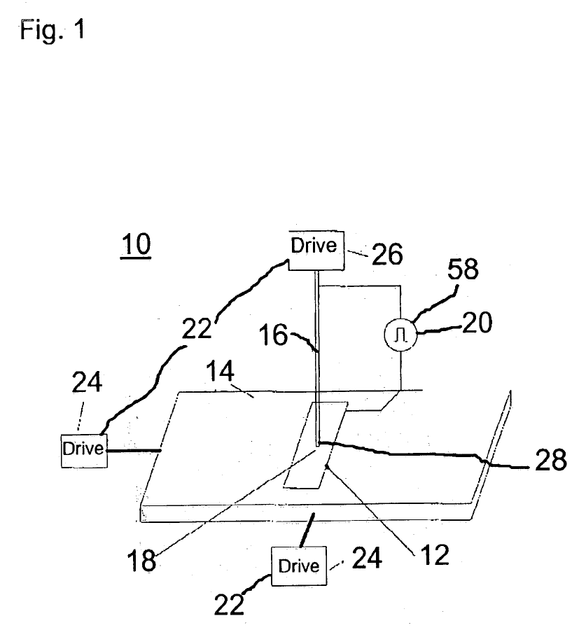

Reference is now made to FIG. 1, which is a schematic isometric view of a system 10 for forming nanostructures on a workpiece electrode arrangement 12 that is constricted and operable in accordance with a preferred embodiment of the present invention. System 10 includes a platform 14. Workpiece electrode arrangement 12 is mounted on platform 14. System 10 includes a counter-electrode 16. Counter-electrode 16 is generally an elongated element having a tip 28, such as a rod, one or more fibers, or a line. A line is defined herein as an elongated flexible element, for example, but not limited to, a conducting wire, thread, woven fiber and ribbon. Counter-electrode 16 is disposed close to a surface of workpiece electrode arrangement 12. The positioning of counter-electrode 16 determines the region in which nanostructures are formed on workpiece electrode arrangement 12, as is described below. Counter-electrode 16 and workpiece electrode arrangement 12 are positioned relative to each other, such that there is a gap 18 between counter-electrode 16 and workpiece electrode arrangement 12. Workpiece electrode arrangement 12 is typically a single workpiece electrode. Optionally workpiece electrode arrangement 12 includes a plurality of workpiece electrodes. System 10 includes an electrical voltage supply 20, typically a pulse generator, which is configured to apply one or more electrical pulses between workpiece electrode arrangement 12 and counter-electrode 16, such that, an electrical discharge in produced in gap 18. The electrical discharge forms one or more nanostructures in a first region of the surface of workpiece electrode arrangement 12. The electrical pulse generally has a duration less than a millisecond and preferably in the range of 0.2 to 20 microseconds. It should be noted that prior art methods for forming nanostructures do not employ a pulsed electrical voltage supply. The electrical pulse generally has a current pulse amplitude in the range of 1 to 100 Amps. The location of the first region is selectively determined by the shape of counter-electrode 16 and particularly the shape of counter-electrode 16 at tip 28 as well as the relative positioning of counter-electrode 16 and workpiece electrode arrangement 12. In other words the shape of counter-electrode 16 and the relative positioning of counter-electrode 16 and workpiece electrode arrangement 12 determine where a nanostructure is formed on the surface of workpiece electrode arrangement 12. Additionally, the shape of counter-electrode 16 determines the size of the first region. The maximum dimension of the first region can be reduced to an order of microns by selecting a suitably thin counter-electrode 16. System 10 also includes a drive mechanism arrangement 22 configured to provide relative movement between workpiece electrode arrangement 12 and counter-electrode 16, such that, counter-electrode 16 and workpiece electrode arrangement 12 can be positioned relative to each other in order to form one or more additional nanostructures in another region of workpiece electrode arrangement 12. Therefore, an array of nanostructures is formed on workpiece electrode arrangement 12 by providing relative movement between workpiece electrode arrangement 12 and counter-electrode 16 and by applying one or more electrical pulses between workpiece electrode arrangement 12 and counter-electrode 16 at each desired location. Electrical voltage supply 20 and drive mechanism arrangement 22 are preferably controlled by a central controller (not shown), for example a programmable controller or computer. The central controller is programmed to produce a pre-determined pattern of nanostructures by positioning a portion of workpiece electrode arrangement 12, where nanostructures are required, opposite tip 28 of counter-electrode 16 and then actuating electrical voltage supply 20. These steps are repeated for each location at which nanostructures are required in order to form a nanostructure array. Drive mechanism arrangement 22 includes two horizontal drive mechanisms 24 and a vertical drive mechanism 26. Drive mechanisms 24 are configured to move platform 14. Drive mechanism 26 is configured to move counter-electrode 16, in order to adjust gap 18 between the surface of workpiece electrode arrangement 12 and tip 28 of counter-electrode 16. Drive mechanisms 24 and drive mechanism 26 include a screw mechanism (not shown) driven by a step motor (not shown) or a piezoelectric translator (not shown), or a combination thereof, depending on the range and precision desired.

The polarity of electrical voltage supply 20 may be set to configure counter-electrode 16 either as a cathode or as an anode.

In order to produce nanostructures which are substantially formed from carbon, such as CNTs, workpiece electrode arrangement 12 and/or counter-electrode 16 need to include carbon, such as graphite. The nanostructures are described as “substantially” formed from carbon in that the carbon nanostructures may include up to 50% non-carbon elements. Typically, in order to produce carbon nanostructures, it is sufficient for a surface region of workpiece electrode arrangement 12 and/or counter-electrode 16 to include, preferably at least 50%, carbon. A surface region of workpiece electrode arrangement 12 is defined herein as a region which faces counter-electrode 16 and the region is sufficiently thick so as to enable formation of CNTs on at least part of workpiece electrode arrangement 12. A surface region of counter-electrode 16 is defined herein as a region which faces workpiece electrode arrangement 12 and the region is sufficiently thick so as to enable formation of CNTs on workpiece electrode arrangement 12. However, in accordance with the most preferred embodiment of the present invention, the whole of counter-electrode 16, and not just a surface region thereof, includes at least 50% carbon. For example, counter-electrode 16 is formed from a carbon rod, one or more carbon fibers or a carbon line. Other examples of suitable materials for workpiece electrode arrangement 12 and/or counter-electrode 16 are described below.

The workpiece and counter-electrode serve as electrical discharge electrodes in this invention. The electrode material, design and polarity strongly influence the effect produced by the electrical discharge. At least one of the discharge electrodes must contain carbon to obtain CNTs. The following are preferred examples of electrode embodiments. By way of a first example, workpiece electrode arrangement 12 is formed from graphite, and CNTs are produced on its surface in the vicinity of the electrical discharge. By way of a second example, workpiece electrode arrangement 12 includes a metal, and counter-electrode 16 includes carbon, for example, counter-electrode 16 is a graphite rod. Certain metals, such as Nickel, are particularly preferred, as it is known by those ordinarily skilled in the art that such metals have a catalytic effect on CNT growth. Therefore, such metals are known as catalytic metals with respect to their effect on CNT growth. By way of a third example, workpiece electrode arrangement 12 is an insulator, such as glass, upon which a thin metal coating is deposited by, for example, filtered vacuum arc deposition. Counter-electrode 16 is graphite. By way of a fourth example, workpiece electrode arrangement 12 is formed of a material, upon which a layer which includes carbon, such as graphite or amorphous diamond-like-carbon is deposited using prior art techniques.

The distance between counter-electrode 16 and the surface of workpiece electrode arrangement 12 influences the nature and dimensions of the nanostructures which are formed. Proper positioning of counter-electrode 16 is complicated by discharge erosion of counter-electrode 16. Therefore, in accordance with the most preferred embodiment of the present invention, the distance between counter-electrode 16 and workpiece electrode arrangement 12 is determined as follows. Drive mechanism 26 of drive mechanism arrangement 22 is configured to move counter-electrode 16 until counter-electrode 16 makes physical contact with workpiece electrode arrangement 12. An electrical sensing apparatus 58 is configured to sense when counter-electrode 16 makes physical contact with workpiece electrode arrangement 12 by measuring electrical resistance between counter-electrode 16 and workpiece electrode arrangement 12. Electrical sensing apparatus 58 and electrical voltage supply 20 are generally implemented as a single control unit. Drive mechanism 26 is additionally configured to withdraw counter-electrode 16 from workpiece electrode arrangement 12 by a pre-determined distance which is measured from the point where physical contact is broken between workpiece electrode arrangement 12 and counter-electrode 16.

In accordance with a preferred embodiment of the present invention, the electrical discharge occurs in a controlled atmosphere, for example, He at a pressure less than atmospheric pressure. The discharge atmosphere is controlled, optionally, either by placing system 10 within a sealed chamber, or by leaving system 10 in ambient air and causing a gas with a pre-determined composition to flow in the vicinity of the electrical discharge. However, in accordance with the most preferred embodiment of the present invention, the electrical discharge occurs in ambient air without the need to control the discharge atmosphere. In other words, the electrical discharge occurs in a substantially uncontrolled atmosphere, such that, additional control of the ambient air atmosphere is not necessary for nanostructure production.

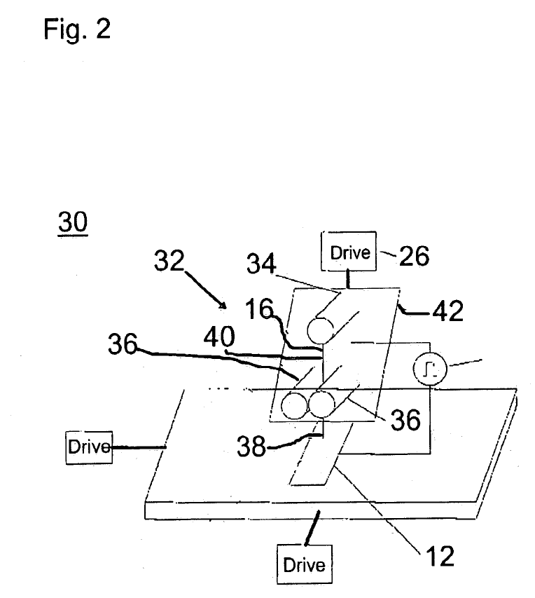

Reference is now made to FIG. 2, which is a schematic isometric view of a system 30 for forming nanostructures on workpiece electrode arrangement 12 that is constructed and operable in accordance with a first alternate embodiment of the present invention. System 30 is the same as system 10 of FIG. 1 except for the following differences. Counter-electrode 16 is a line. The line includes one or more carbon fibers, such as a woven graphite thread. Graphite fiber, typically with a diameter of 7 microns, is commercially available and widely used in forming threads which are woven in graphite based textiles, which are widely used for composite materials in the aerospace industry. The graphite fiber electrode has the advantage of being very thin, and hence facilitating the precise localization of the discharge, and hence the location of the CNT formation on the surface of workpiece electrode arrangement 12. It will be apparent to those ordinarily skilled in the art that the line can be formed from other materials, for example, but not limited to, a graphite fiber or bundles of graphite fibers in the form of tows, threads, or yarn. System 30 includes a release mechanism arrangement 32. Release mechanism arrangement 32 includes a spool 34 and two rollers 36. Spool 34 and rollers 36 are mounted on a common base 42. Common base 42 is mechanically connected to drive mechanism 26. Release mechanism arrangement 32 is configured to release an end 38 of the line towards workpiece electrode arrangement 12. The line is supplied by spool 34 upon which the line is wound. Rollers 36, which are motorized, grip and move the line in order to extract a controlled amount of the line, periodically, from spool 34, so that a free section 40 of the line has an approximately constant length even though at least part of free section 40 is consumed during each discharge. In accordance with this first alternate embodiment of the present invention, drive mechanism 26 preferably has a sub-micron precision. For example, drive mechanism 26 includes a piezoelectric translator.

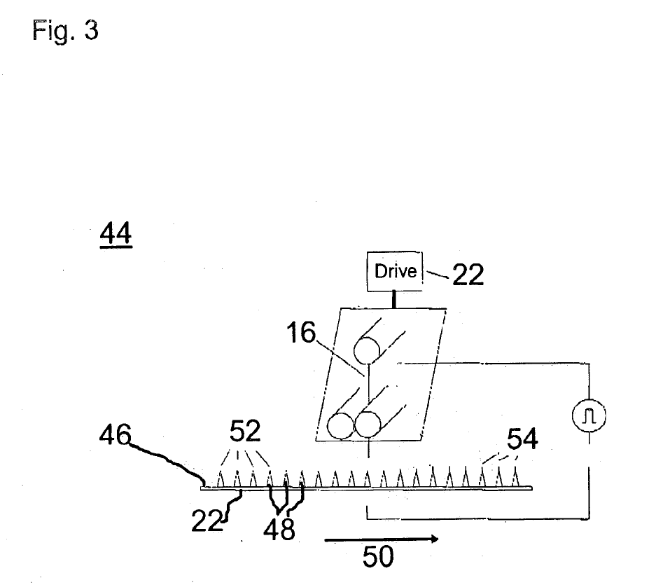

Reference is now made to FIG. 3, which is a schematic isometric view of a system 44 for forming nanostructures on a plurality of workpieces that is constricted and operable in accordance with a second alternate embodiment of the present invention In accordance with this second alternate embodiment, workpiece electrode arrangement 12 includes a plurality of workpieces 48. System 44 is the same as system 30 of FIG. 2 except for the following differences. Drive mechanism arrangement 22 includes a conveyor apparatus 46 instead of using platform 14 and drive mechanisms 24. Conveyor apparatus 46 is configured for disposing workpieces 48 thereon. Actuating conveyor apparatus 46 provides relative movement between workpieces 48 and counter-electrode 16. For example, workpieces 48 are tips for scanning tunneling microscopy, upon each of which it is desirable to fabricate a single CNT probe. An arrow 50 indicates the direction of travel of workpieces 48 on conveyor apparatus 46. FIG. 3 shows untreated workpieces 52 without CNTs and treated workpieces 54 with CNTs.

The mechanism of action of CNT formation of the present invention is not precisely known, but it is possible that CNT formation of the present invention includes the following elements. First, the electrical discharge generates carbon vapor from one or both of the electrodes. If a controlled atmosphere is employed with a carbon-containing cathode, the intense heating in the cathode spot may play a key role in the carbon vapor generation. Likewise concentrated heating at small diameter counter-electrodes 16, with either polarity, is likely to evaporate material from it. Second, some of the carbon vapor is excited or ionized in the discharge. Third, workpiece electrode arrangement 12 is locally heated by the discharge. Fourth, the carbon vapor condenses on the surface of workpiece electrode arrangement 12 under conditions favorable for CNT formation.

The system and method of the present invention have the following advantages over the prior art systems and methods for CNT formation. First, the method of the present invention can be performed in ambient air, and thus expensive vacuum chambers are not required. Second, the CNTs of the present invention are deposited directly on to the surface of workpiece electrode arrangement 12, in contrast to the conventional arc method in which the CNTs must be collected and then printed onto a workpiece. Third, the CNTs of the present invention are generated in selected locations, without requiring masking or pre-deposition of a catalytic pattern. Fourth, the process of the present invention is fast whereby CNTs are produced with a single sub-microsecond pulse.

Reference is again made to FIG. 1. Several illustrative examples of the application of the present invention are described below. The illustrative examples are based on performing the method of the present invention using system 10 to form CNTs on workpiece electrode arrangement 12. Drive mechanism arrangement 22 was implemented using step motors controlled by a personal computer based control system. Electrical voltage supply 20 was actuated to sustain pulsed arcs in air between counter-electrode 16 and workpiece electrode arrangement 12. The arcs were ignited either by using a contact mode or a breakdown mode. In contact mode, counter-electrode 16 was mounted on a vibrator, which periodically, at 100 Hz, caused counter-electrode 16 to make contact with workpiece electrode arrangement 12, while a voltage was applied between workpiece electrode arrangement 12 and counter-electrode 16. In breakdown mode, sufficiently high voltage pulses were applied between workpiece electrode arrangement 12 and counter-electrode 16 in order to breakdown gap 18 between counter-electrode 16 and workpiece electrode arrangement 12.

In the contact mode, the pulse repetition frequency was synchronous with the vibration frequency, in other words 100 Hz. A processing time of one second was employed. Although the step motors were not actuated during this processing time, the point of contact of the arc on the surface of workpiece electrode arrangement 12 is not exactly repeated with this set-up, but rather the point of contact is randomly distributed about a mean location.

In breakdown mode, the pulse repetition rate was 1 kHz, and gap 18 was set at 0.3 millimeters. A sequence of 15-20 pulses was employed while moving platform 14 by a step of 0.01 millimeters between each pulse. Pulse ignition and the step motor motion were controlled by the personal computer using a control program written with LabVIEW. LabVIEW is commercially available from National Instruments Corporation of 11500 North Mopac Expressway, Austin, Tex. 78759-3504.

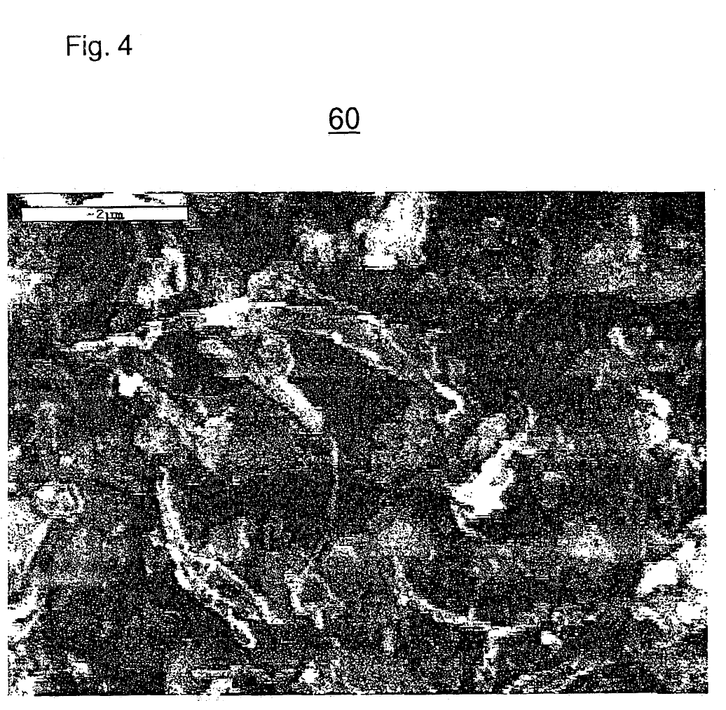

A set of 16 sample workpieces was treated. The treatment conditions and results are summarized in Table 1 below. The surface morphology of the treated workpieces was studied with scanning electron microscopy (SEM). The graphite samples processed using contact mode had multiple treated regions consisting of concentric zones. These concentric zones had a central zone, an inner annular zone and an outer annular zone. The central zone had a smooth-walled crater of approximately 5 microns diameter. The inner annular zone had an outer diameter of approximately 200 microns. The inner zone had a fine-grain structure in the range of 0.3 to 0.5 microns. The outer annular zone had an outer diameter of approximately 400 microns. The outer zone had grain diameters of between 1 and 3 microns. Each treated region is assumed to be associated with a single electric pulse. Fiber-like nanostructures with characteristic diameters of approximately 10 nanometers and lengths of approximately 1000 nanometers, presumed to be CNTs, were observed on some of the sample workpieces. CNTs were randomly orientated on the workpiece surfaces. In some case, these nanostructures appeared to be tangled into a thread-like structure. Nanostructures were observed in the central and outer annular zones of the treated regions on some of the graphite samples. See the results for samples 1 to 4 in Table 1. In particular, it should be noted that nanostructures were observed on all of the graphite workpiece samples which were processed with a graphite counter-electrode. Reference is now made to FIG. 4, which is a scanning electron micrograph of a plurality of carbon nanostructures 60 fabricated using system 10 of FIG. 1. Nanostructures 60 were found on sample 3 of Table 1 in which the workpiece and the counter-electrode were graphite. For samples, where only one of the electrodes was graphite, the results were mixed. When a thin steel cathode counter-electrode was employed opposite a graphite workpiece serving as the arc anode, islands with a typical diameter of 100 microns were observed on the graphite surfaces, but fibrous nanostructures were not observed. See the results for samples 5 and 6 in Table 1. These islands are assumed to be steel deposited from the counter-electrode. Samples 5 and 6, with the presumed steel islands, were then used as in additional experiments as sample workpieces 7 and 8, respectively, whereby a thin graphite counter-electrode was used. CNTs were observed on the islands of samples 7 and 8. Steel, Copper and Nickel workpieces were pulse arc treated in breakdown mode using a thin graphite counter-electrode. See the results for samples 11 to 16 in Table 1. Craters were observed having a diameter of 1 micron for Nickel and a diameter of less than 1 micron for Copper. However, the zone structure described above for graphite samples was not observed for samples 11 to 16. A filamentary structure similar to that described above with reference to graphite was observed only in the case of Nickel samples, wherein the filamentary structures were generally attached to the crater rims.

Table 1 is shown below. In Table 1, the results for the number of CNTs observed per sample are represented by a symbol. The explanation of the symbols is as follows. The symbol “/” denotes that a CNT was probably present. However, the CNT cannot be identified with 100% certainty due to poor SEM contrast. The symbol “+” denotes that CNTs were observed and the symbol “++” denotes that a high nanotube density was observed, the CNTs covering more than 8% of area treated.

TABLE 1
Results of Tests to Form CNTs on Flat Workpiece Samples

| | | Peak | Pulse | Counter- | Counter- | Counter Elec- | Workpiece | Sample | |
|---|---|---|---|---|---|---|---|---|---|
| Sample | | Current, | Width, | Electrode | Electrode | trode Cross- | Sample | Size, | CNTs |
| No. | Mode | Amps | μs | Polarity | Material | section, mm | Material | mm | Observed |
| 1 | Contact | 66 | 7 | Positive | Graphite | 1 × 4 | Graphite | 10 × 10 | + |
| 2 | Contact | 66 | 7 | Positive | Graphite | 1 × 4 | Graphite | 10 × 10 | + |
| 3 | Contact | 66 | 14 | Positive | Graphite | 1 × 4 | Graphite | 10 × 10 | ++ |
| 4 | Contact | 33 | 20 | Positive | Graphite | 1 × 4 | Graphite | 10 × 10 | ++ |
| 5 | Breakdown | 10 | 0.2 | Negative | Steel | 0.1 diameter | Graphite | 10 × 10 | None |
| 6 | Breakdown | 7 | 0.2 | Negative | Steel | 0.1 diameter | Graphite | 10 × 10 | None |
| 7 | Breakdown | 7 | 0.2 | Negative | Graphite | 1 × 4 | Graphite | 10 × 10 | + |
| | | | | | | | with steel | | |
| | | | | | | | islands | | |
| 8 | Breakdown | 10 | 0.2 | Negative | Graphite | 1 × 4 | Graphite | 10 × 10 | + |
| | | | | | | | with steel | | |
| | | | | | | | islands | | |
| 9 | Breakdown | 7 | 0.2 | Negative | Graphite | 1 × 4 | Graphite | 10 × 10 | + |
| 10 | Breakdown | 7 | 0.2 | Positive | Graphite | 1 × 4 | Graphite | 10 × 10 | ++ |
| 11 | Breakdown | 10 | 0.2 | Positive | Graphite | 1 × 4 | Steel | 20 × 10 | None |
| 12 | Breakdown | 10 | 0.2 | Negative | Graphite | 1 × 4 | Steel | 20 × 10 | None |
| 13 | Breakdown | 10 | 0.2 | Negative | Graphite | 1 × 4 | Copper | 15 × 4 | None |
| 14 | Breakdown | 10 | 0.2 | Positive | Graphite | 1 × 4 | Copper | 15 × 4 | None |
| 15 | Breakdown | 10 | 0.2 | Negative | Graphite | 1 × 4 | Nickel | 15 × 4 | / |
| 16 | Breakdown | 10 | 0.2 | Positive | Graphite | 1 × 4 | Nickel | 15 × 4 | / |

Further tests were performed by applying a single electrical pulse to a workpiece formed from a 200 mesh copper grid coated with a carbon film. This type of workpiece is commonly used to support samples for examination in a transmission electron microscope (TEM). All of these tests were performed using breakdown mode, with a pulse-width of 0.2 microseconds and a breakdown voltage of approximately one kilovolt. Conditions of these tests are summarized below in Table 2.

TABLE 2
Nanotube Production on TEM Grids

| | Peak | | Counter- | Counter-Electrode |
|---|---|---|---|---|
| Sample | Current, | Counter-Electrode | Electrode | Cross-section Size, |
| No. | Amps | Polarity | Material | mm |
| 1 | 10 | Negative | Steel | 0.1 diameter |
| 2 | 10 | Negative | Steel | 0.1 diameter |
| 3 | 10 | Positive | Steel | 0.1 diameter |
| 4 | 7 | Positive | Steel | 0.1 diameter |
| 5 | 7 | Positive | Steel | 0.1 diameter |
| 6 | 7 | Negative | Steel | 0.1 diameter |
| 7 | 7 | Positive | Graphite | 1 × 4 |
| 8 | 7 | Negative | Graphite | 1 × 4 |
| 9 | 10 | Positive | Graphite | 1 × 4 |
| 10 | 10 | Negative | Graphite | 1 × 4 |

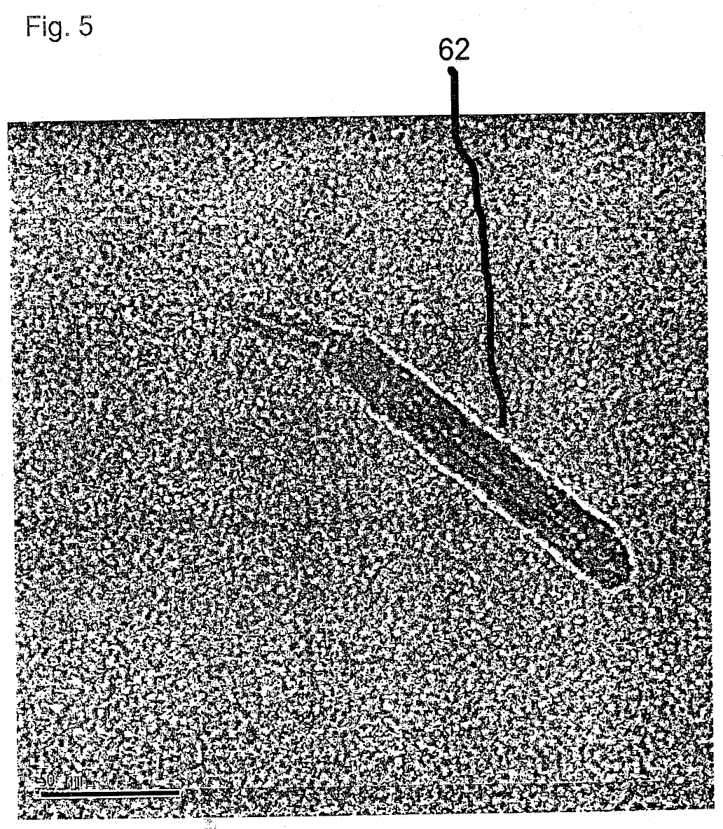

The workpieces were examined with transmission electron microscopy. CNTs were found in all samples. Reference is now made to FIG. 5, which is a transmission electron micrograph of a carbon nanotube 62 fabricated using system 10 of FIG. 1. Nanotube 62 was found on Sample 10 of Table 2.

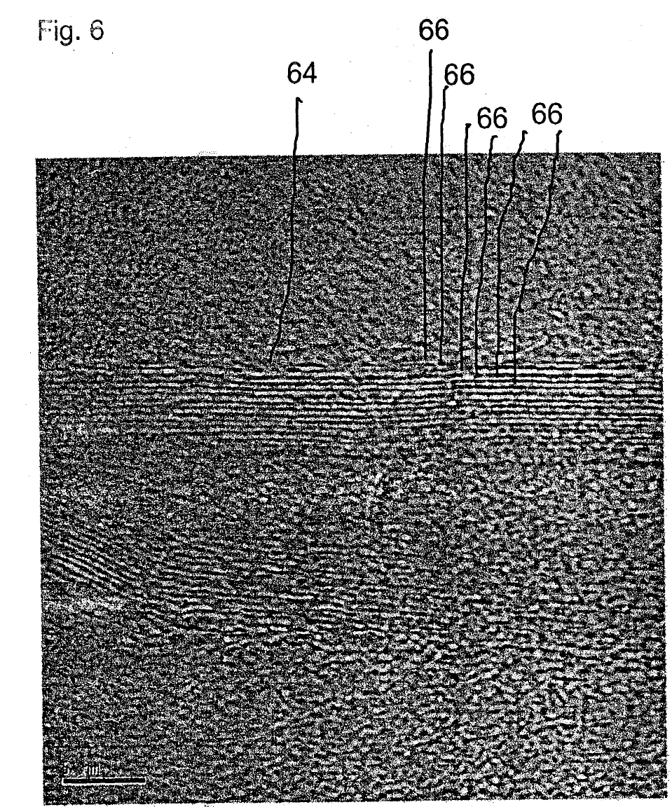

Reference is now made to FIG. 6, which is a high-resolution electron micrograph of a carbon nanotube 64 fabricated using system 10 of FIG. 1. Carbon nanotube 64 has multiple walls 66.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description.

What is claimed is:

1. A method for forming nanostructures on a workpiece, comprising the steps of:
(a) positioning a counter-electrode and a workpiece electrode arrangement relative to each other, such that, there is a gap between said counter-electrode and said workpiece electrode arrangement; and
(b) applying an electrical pulse between said workpiece electrode arrangement and said counter electrode, such that, an electrical discharge in produced in said gap, said electrical discharge forming at least one nanostructure in a first region of a surface of said workpiece electrode arrangement, said electrical pulse having a duration of less than one millisecond.

2. The method of claim 1, wherein a maximum dimension of said first region is less than one millimeter.

3. The method of claim 1, wherein said electrical pulse has a current pulse amplitude between 1 and 100 Amps.

4. The method of claim 1, wherein said electrical discharge is produced in a substantially uncontrolled ambient air atmosphere.

5. The method of claim 1, further comprising the steps of:
(c) providing relative movement between said counter-electrode and said workpiece electrode arrangement; and
(d) applying another electrical pulse between said workpiece electrode arrangement and said counter electrode in order for an electrical discharge to form at least one nanostructure in a second region of the surface of said workpiece arrangement, said other electrical pulse having a duration of less than one millisecond.

6. The method of claim 1, further comprising the step of:
(c) selecting a shape of said counter-electrode and a relative positioning of said workpiece electrode arrangement and said counter-electrode in order to selectively determine said first region.

7. The method of claim 1, further comprising the steps of:
(c) disposing said workpiece electrode arrangement on to a conveyor system; and
(d) actuating said conveyor system so as to provide relative movement between said workpiece electrode arrangement and said counter-electrode.

8. The method of claim 1, wherein said counter-electrode includes a carbon rod.

9. The method of claim 1, wherein said counter-electrode includes carbon and said workpiece electrode arrangement includes a catalytic metal.

10. A method for forming nanostructures on a workpiece, comprising the steps of:
(a) positioning a counter-electrode and a workpiece electrode arrangement relative to each other, such that, there is a gap between said counter-electrode and said workpiece electrode arrangement; and
(b) producing an electrical discharge in said gap, said electrical discharge forming at least one nanostructure in a first region of a surface of said workpiece electrode arrangement, wherein said first region is selectively determined by a shape of said counter-electrode and a relative positioning of said workpiece electrode arrangement and said counter-electrode.

11. The method of claim 10, wherein said step of producing said electrical discharge in said gap is performed by applying an electrical pulse between said workpiece electrode arrangement and said counter electrode.

12. The method of claim 10, wherein a maximum dimension of said first region is less than one millimeter.

13. The method of claim 10, wherein said electrical discharge is produced in an atmosphere of at least 50% Helium.

14. The method of claim 10, wherein said electrical discharge is produced in a substantially uncontrolled ambient air atmosphere.

15. The method of claim 10, further comprising the steps of:
(c) providing relative movement between said counter-electrode and said workpiece electrode arrangement; and
(d) producing another electrical discharge in said gap, in order to form at least one other nanostructure in a second region of the surface of said workpiece arrangement.

16. The method of claim 10, wherein said counter-electrode includes an elongated element having a tip.

17. The method of claim 10, wherein said counter-electrode includes a rod.

18. The method of claim 10, wherein said counter-electrode includes a fiber.

19. The method of claim 10, further comprising the steps of:
(c) moving said counter-electrode until said counter-electrode makes a physical contact with said workpiece electrode arrangement;
(d) electrically sensing when said counter-electrode makes said physical contact with said workpiece electrode arrangement; and
(e) withdrawing said counter-electrode from said workpiece electrode arrangement by a pre-determined distance.

20. The method of claim 10, wherein said counter-electrode includes a line.

21. The method of claim 20, further comprising the step of:
(c) releasing an end of said line towards said workpiece electrode arrangement.

22. The method of claim 20, wherein said line includes a plurality of carbon fibers.

23. The method of claim 10, further comprising the steps of:
(c) disposing said workpiece electrode arrangement on to a conveyor system; and
(d) actuating said conveyor system so as to provide relative movement between said workpiece electrode arrangement and said counter-electrode.

24. The method of claim 10, wherein said nanostructure is substantially formed from carbon and wherein at least one of said workpiece electrode arrangement and said counter-electrode include carbon.

25. The method of claim 24, wherein at least one of said workpiece electrode and said counter-electrode has a surface region including at least fifty-percent carbon.

26. The method of claim 24, wherein said counter-electrode includes at least fifty-percent carbon.

27. The method of claim 24, wherein said counter-electrode includes a carbon rod.

28. The method of claim 24, wherein said counter-electrode includes a carbon fiber.

29. The method of claim 24, wherein said counter-electrode includes carbon and said workpiece electrode arrangement includes a catalytic metal.

30. The method of claim 10, wherein said step of producing is performed, such that, said electrical discharge forms at least one carbon nanotube in said first region.

31. The method of claim 10, wherein said counter-electrode is a cathode.

32. The method of claim 10, wherein said counter-electrode is an anode.

33. A system for producing nanostructures, comprising:
(a) a workpiece electrode arrangement having a surface;
(b) a counter-electrode, at least one of said workpiece electrode arrangement and said counter-electrode including carbon, said workpiece electrode arrangement and said counter-electrode being positioned, such that, there is a gap between said workpiece electrode arrangement and said counter-electrode; and
(c) an electrical voltage supply, said electrical voltage supply being configured to produce an electrical discharge in said gap so as to form at least one carbon-nanotube in a first region of said surface, wherein said counter-electrode is formed in order to selectively determine said first region.

34. The system of claim 33, wherein said first region has a maximum dimension, said maximum dimension being less than one millimeter.

35. The system of claim 33, wherein a part of said gap in which said electrical discharge is produced has an atmosphere of at least 50% Helium.

36. The system of claim 33, wherein a part of said gap in which said electrical discharge is produced has a substantially uncontrolled ambient air atmosphere.

37. The system of claim 33, further comprising:
(d) a drive mechanism arrangement configured to provide relative movement between said workpiece electrode arrangement and said counter-electrode, such that, said electrical voltage supply is configured to produce another electrical discharge in order to form at least one other carbon-nanotube in a second region on said surface of said workpiece electrode arrangement.

38. The system of claim 37, wherein said drive mechanism arrangement includes a conveyor apparatus configured for disposing said workpiece electrode arrangement thereon.

39. The system of claim 33, wherein at least one of said workpiece electrode and said counter-electrode has a surface region including at least fifty-percent carbon.

40. The system of claim 33, wherein said counter-electrode includes at least fifty-percent carbon.

41. The system of claim 33, wherein said electrical voltage supply is configured to produce at least one electrical pulse in order to produce said electrical discharge, said electrical pulse having a duration of less than one millisecond.

42. The system of claim 41, wherein said electrical pulse has a current pulse amplitude between 1 and 100 Amps.

43. The system of claim 33, wherein said counter-electrode includes an elongated element having a tip.

44. The system of claim 33, wherein said counter-electrode includes a rod.

45. The system of claim 33, wherein said counter-electrode includes a fiber.

46. The system of claim 33, further comprising:
(d) a drive mechanism arrangement configured to move said counter-electrode until said counter-electrode makes a physical contact with said workpiece electrode arrangement; and
(e) an electrical sensing apparatus configured to sense when said counter-electrode makes said physical contact with said workpiece electrode arrangement, wherein said drive mechanism arrangement is configured to withdraw said counter-electrode from said workpiece electrode arrangement by a pre-determined distance.

47. The system of claim 33, wherein said counter-electrode includes a line.

48. The system of claim 47, further comprising:
(d) a release mechanism arrangement configured to release an end of said line towards said workpiece electrode arrangement.

49. The system of claim 47, wherein said line includes a plurality of carbon fibers.

50. The system of claim 33, wherein at least one of said workpiece electrode arrangement and said counter-electrode includes graphite.

51. The system of claim 33, wherein said electrical voltage supply is configured to operate said counter-electrode as a cathode.

52. A system for producing nanostructures, comprising:
(a) a workpiece electrode arrangement having a surface;
(b) a counter-electrode, said workpiece electrode arrangement and said counter-electrode being positioned, such that, there is a gap between said workpiece electrode arrangement and said counter-electrode; and
(c) an electrical voltage supply, said electrical voltage supply being configured to produce an electrical discharge in said gap so as to form at least one nanostructure in a first region of said surface, wherein said electrical voltage supply is configured to operate said counter-electrode as a cathode.

53. The system of claim 52, wherein said first region has a maximum dimension, said maximum dimension being less than one millimeter.

54. The system of claim 52, wherein a part of said gap in which said electrical discharge is produced has a substantially uncontrolled ambient air atmosphere.

55. The system of claim 52, wherein said electrical voltage supply is configured to produce at least one electrical pulse in order to produce said electrical discharge, said electrical pulse having a duration of less than one millisecond.

56. The system of claim 55, wherein said electrical pulse has a current pulse amplitude between 1 and 100 Amps.
